(19) United States
(12) Patent Application Publication
(10) Pub. No.: US 2026/0007277 A1
(43) Pub. Date: Jan. 8, 2026

(54) Noodle Eating Utensil

(71) Applicant: Stephen Koch, Durango, CO (US)

(72) Inventor: Stephen Koch, Durango, CO (US)

(21) Appl. No.: 19/260,474

(22) Filed: Jul. 5, 2025

Related U.S. Application Data
(60) Provisional application No. 63/668,258, filed on Jul. 7, 2024.

(51) Int. Cl. A47J 43/28

(52) U.S. Cl. CPC A47J 43/28

(57) ABSTRACT

A food utensil designed for use in eating noodles. The utensil may include a handle portion and a food holding portion with food gripping members extending therefrom. The user may hold the utensil by the handle portion and engage the food holding portion with noodles, e.g., with noodles within a bowl of soup. The food gripping members may include protrusions designed to grip the noodles so that the noodles may be transferred to the user's mouth without slipping off the utensil and causing a mess.

### CROSS-REFERENCE TO RELATED APPLICATIONS

This application claims priority to U.S. Provisional Application No. 63/668,258 filed Jul. 7, 2024, the entire contents of which are hereby fully incorporated herein by reference for all purposes.

### FIELD OF THE INVENTION

The field of the current invention regards eating utensils, including an eating utensil for noodles.

### BACKGROUND

Noodles are consumed throughout the world by many different cultures on a daily basis. For example, noodles may be included in pasta dishes, in noodle soups, and as standalone noodle dishes.

When noodles are served on a plate (e.g., as part of a pasta dish), the person eating the noodles may oftentimes use a fork, chopsticks, or other types of eating utensils to transfer the noodles from the dish to his/her mouth. In this scenario, the noodles may not be overly slippery and may be eaten without excessive difficulties.

However, when served within a bowl of soup, the noodles may become overly slippery and difficult to grasp with the utensil, especially if the consumer attempts to eat the noodles using a spoon or chopsticks (which are both customary when eating soup). In this scenario, the noodles may easily slip off of the utensil thereby causing a messy and unpleasant eating experience.

Accordingly, there is a need for an improved noodle eating utensil.

### SUMMARY OF THE INVENTION

According to one aspect, one or more embodiments are provided below for a noodle eating utensil. The utensil may include a handle member including a first end and a second end, a food holding member coupled to the first end of the handle member, and at least one food gripping mechanism coupled to the food holding member and extending outward therefrom;

In another embodiment, the at least one food gripping mechanism includes a protrusion adapted to grip at least one noodle.

In another embodiment, the food holding member includes an upper surface and the at least one food gripping mechanism is coupled to the upper surface.

In another embodiment, the at least one food gripping mechanism includes a plurality of food gripping mechanisms arranged in one or more rows and in one or more columns coupled to the upper surface.

In another embodiment, the one or more rows includes a total of six to ten rows and the one or more columns includes a total of two to three columns.

In another embodiment, the food holding member includes an upper surface and a first side surface and a first at least one food gripping mechanism is coupled to the upper surface and a second at least one food gripping mechanism is coupled to the side surface.

In another embodiment, the at least one food gripping mechanism includes a first plurality of food gripping mechanisms arranged in one or more first rows and in one or more first columns coupled to the upper surface and a second plurality of food gripping mechanisms arranged in one or more second rows and in one or more second columns coupled to the first side surface.

In another embodiment, the one or more first rows includes a first total of six to eight first rows and the one or more first columns includes a second total of two to three first columns, and the one or more second rows includes a third total of six to eight second rows and the one or more second columns includes a fourth total of two to three second columns.

In another embodiment, a first of the one or more columns is offset from a second of the one or more columns.

In another embodiment, a first of the one or more rows is offset from a second of the one or more rows.

In another embodiment, the food holding member includes a proximal end and a distal end defining a member longitudinal axis, and a cross-section of the food holding member taken perpendicular to the member longitudinal axis is square, rectangular, circular, oval, or polygonal.

In another embodiment, the cross-section of the food holding member is triangular.

In another embodiment, the triangular cross-section includes a first leg and a second leg, and a first at least one food gripping mechanism is coupled to the first leg and a second at least one food gripping mechanism is coupled to the second leg.

In another embodiment, the first at least one food gripping mechanism includes a first plurality of food gripping mechanisms arranged in one or more first rows and in one or more first columns, and the second at least one food gripping mechanism includes a second plurality of food gripping mechanisms arranged in one or more second rows and in one or more second columns.

In another embodiment, the one or more first rows includes a first total of six to ten first rows and the one or more first columns includes a second total of two to three first columns, and the one or more second rows includes a third total of six to ten second rows and the one or more second columns includes a fourth total of two to three second columns.

In another embodiment, the food holding member includes a first surface and the at least one food gripping mechanism extends perpendicular from the first surface.

In another embodiment, the food holding member includes a first surface and the at least one food gripping mechanism extends at an offset angle with respect to the first surface.

Other aspects and embodiments of the invention are discussed herein.

### BRIEF DESCRIPTION OF THE DRAWINGS

While this invention may be embodied in many different forms, there are described in detail herein specific embodiments of the invention. This description is an exemplification of the principles of the invention and is not intended to limit the invention to the particular embodiments illustrated.

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows an isotropic view of an eating utensil according to exemplary embodiments hereof;

FIGS. 2-3 show side views of an eating utensil according to exemplary embodiments hereof;

FIG. 4 shows aspects of a food holding portion according to exemplary embodiments hereof;

FIGS. 5-10 show example cross-sections of a food holding portion according to exemplary embodiments hereof;

FIGS. 11-12 show example food gripping mechanisms according to exemplary embodiments hereof; and

FIG. 13 shows example food holding portions according to exemplary embodiments hereof.

### DETAILED DESCRIPTION OF EXEMPLARY EMBODIMENTS

The current invention is now described with reference to the figures. Though the following description may focus on the use of stabilization assemblies, systems or devices with archery bows, the current invention is applicable to other apparatus.

In general, current invention includes a noodle eating utensil comprising a handle with a food holding portion designed to easily engage, hold, and transfer noodles from a serving dish (e.g., a bowl of noodle soup) to the consumer's mouth without the noodles slipping and causing a mess. As described herein, the food holding portion may include specially designed noodle gripping members to facilitate its use.

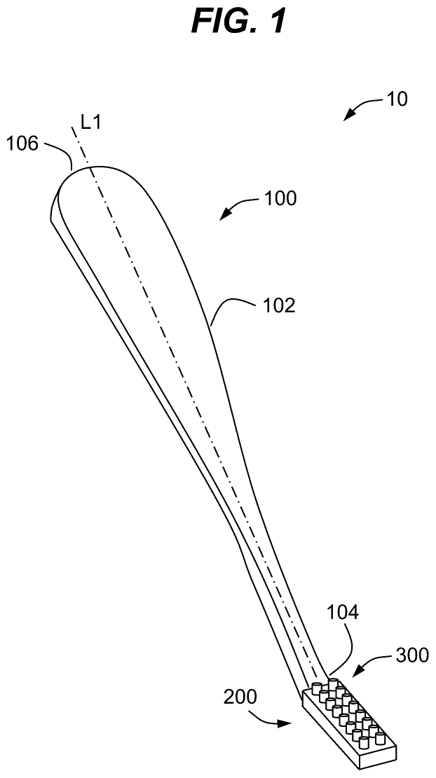

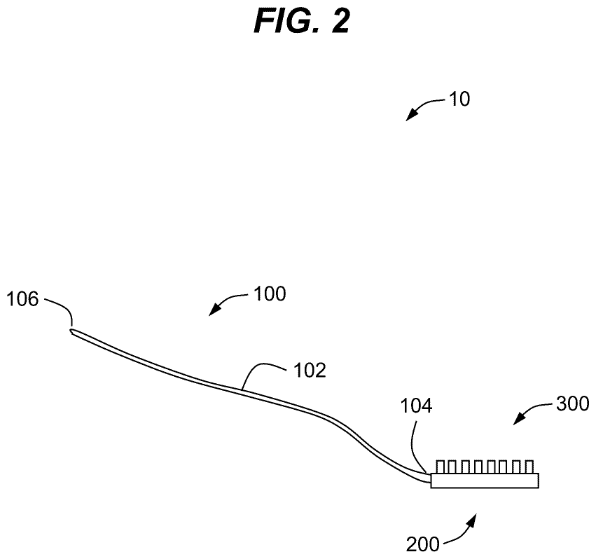

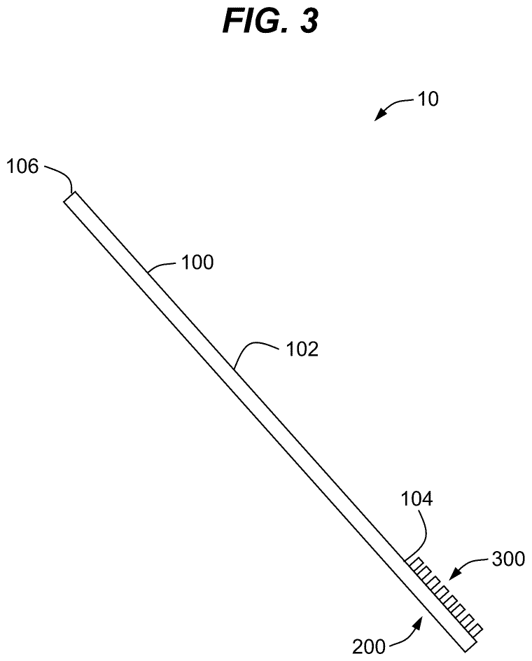

FIG. 1 shows an isometric view of a noodle eating utensil 10 including a handle portion 100 coupled to a food holding portion 200 with food gripping mechanisms 300, and FIG. 2 shows a side view of the same. FIG. 3 shows a side view of an alternative embodiment of the noodle eating utensil 10.

In general, in some embodiments, a user may utilize the noodle eating utensil 10 (also referred to herein as simply the utensil 10) by grasping the handle portion 100, engaging the food holding portion 200 with one or more noodles (e.g., dipping the portion 200 into a bowl of noodle soup), and then transferring the one or more noodles to his/her mouth via the utensil 10. During this process, the food gripping mechanisms 300 configured with the food holding portion 200 may grip and hold the noodles from falling off of the portion 200 such that the noodles may be easily placed into the user's mouth and consumed.

For the purposes of this specification, the utensil 10 will be described primarily with respect to its use with eating noodles or other similar types of food. However, it is understood that the utensil 10 also may be used to eat other types of food that may benefit from its form and architecture, and that the scope of the utensil 10 is not limited in any way by the types of food that it may be used with.

### Handle Portion 100

In some embodiments, as shown in FIG. 1, the handle portion 100 may include a handle member 102 including a proximal end 104 and a distal end 106 defining a handle longitudinal axis L1. In some embodiments, the proximal end 104 may be coupled to the food holding portion 100 with the distal end 106 extending away therefrom.

In some embodiments, the handle member 102 may be elongate and may be ergonomically dimensioned so that it may be easily gripped and used using one hand. As shown in FIG. 1, the width of the handle member 102 may flare outwards towards its distal end 106, but this may not be necessary. In addition, while the cross-section of the handle member 102 in FIG. 1 (e.g., taken perpendicular to the longitudinal axis L1) is shown to be generally rectangular, other cross-sectional shapes may be implemented. For example, the handle member 102 may include cross-sectional shapes such as, but not limited to, circular, oval, square, trapezoidal, octagonal, polygonal, other shapes, and/or any combinations thereof.

In some embodiments, the handle member 102 may include one or more curvatures along its body between its proximal end 104 and its distal end 106. For example, as shown in FIG. 2, the handle member 102 may include an upward extending hump and/or other type(s) of curvatures that may properly orient the utensil's food holding portion 200 to easily engage noodles within a bowl or on a plate when the utensil body 102 is held.

In other embodiments, as shown in FIG. 3, the handle portion 100 may be a generally linear elongate member resembling a chopstick. In this embodiment, the food holding portion 200 may be formed integrally with the proximal end of the handle portion 100 as an extension thereof. In addition, while the utensil 10 of FIG. 3 is shown to have a constant diameter along its length, it is understood that the utensil's diameter may taper in and/or out in any portions. For example, the utensil 10 may taper from a larger diameter at its distal end 106 to a smaller diameter at its proximal end 104, or vice versa.

Food Holding Portion 200 with Food Gripping Mechanisms 300

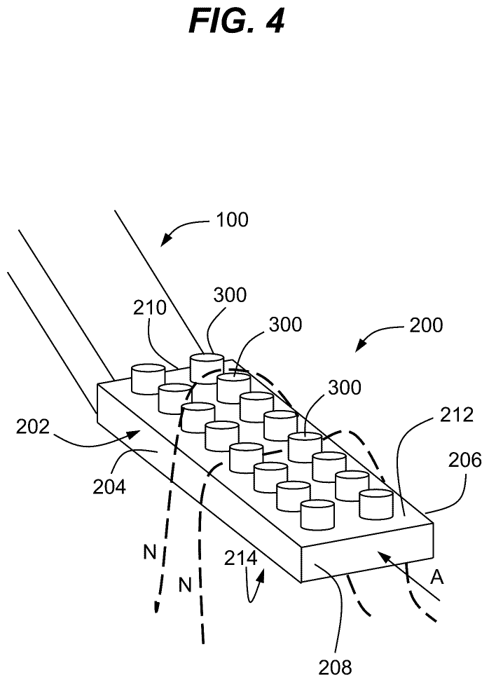

FIG. 4 shows a close-up view of the food holding portion 200 of FIGS. 1-3. The portion 200 is shown holding two example noodles N (represented as a dashed lines).

In some embodiments, as shown in FIG. 4, the food holding portion 200 may include a food holding body 202 including a left side 204, a right side 206, a front end 208, a back end 210, a top side 212, and a bottom side 214. As will be described in detail in other sections, the body 202 may be configured with one or more food gripping mechanisms 300, e.g., coupled to its top side 212 as shown.

In some embodiments, the food holding body 202 may generally extend linearly from its front end 208 to its back end 210, however it also is contemplated that the body 202 may include one or more curvatures between its front end 208 and its back end 210 as described in other sections.

In some embodiments, as shown in FIG. 4, the food holding body 202 may include a generally rectangular cross-section when looking into the body's front end 208 in the direction of the arrow A. In this embodiment, the body's top side 212 may be generally flat from the front end 208 to the back end 210. The top side 212 may be configured with one or more food gripping mechanisms 300, e.g., with the food gripping mechanisms 300 being coupled to and extending upward and away from the top side 212.

While the front end 208 of the food holding body 202 is shown as having sharp edges, it is understood that the front end 208 may include rounded edges, a tapered or rounded front end 208 (e.g., hemispherical, ellipsoid, etc.), and/or other forms.

In some embodiments, the food gripping mechanisms 300 may include one or more protrusions (e.g., nubs or teeth) that extend upward orthogonally from the body's top side 212 and that may be designed to engage and hold one or more noodles. The shape(s) and form(s) of the mechanisms 300 will be described in other sections. As shown in FIG. 4, a plurality of food gripping mechanisms 300 may be arranged and configured to generally trap, snag, or otherwise hold one or more noodles N on and/or in between adjacent mechanisms 300. For example, as shown in FIG. 4, a first noodle N towards the front 208 is shown to be held in between adjacent mechanisms 300 and a second noodle N towards the back 210 is shown to be held by the bodies and/or by the upper features of the mechanisms 300 (e.g., by the mechanism's side and/or top edges) It is appreciated that the noodles N may be held by any portions of the food gripping mechanisms 300. In this way, the noodles N may be gently held by the mechanisms 300 so that the noodle N may not fall off of the food holding portion 200 as the noodles N are transferred from the bowl to the user's mouth. The user may insert the food holding portion 200 and the accompanying noodles N into his/her mouth, and then release the noodles by simply closing his/her mouth and sliding the food holding portion 200 outward. This motion may preferably leave the noodles within the mouth cavity for consumption. As such, the noodles N are preferably only released when desired (e.g., once inside the user's mouth).

In some embodiments, as shown in FIG. 4, the food gripping mechanisms 300 may be arranged on the top surface 212 of the food holding body 202 in rows and columns. For example, the mechanisms 300 may be arranged in eight rows and two columns (i.e., in an 8×2 matrix) as shown.

In other embodiments, the mechanisms 300 may be arranged in any suitable m×n matrix where m equals the number of rows and n equals the number of columns. For example, the mechanisms 300 may be arranged in 6×2, 7×2, 9×2, 10×2, 11×2, 12×2, 6×3, 7×3, 8×3, 9×3, 10×3, 11×3, 12×3, in other numbers and arrangements of m rows and n columns, and/or in any combinations thereof. It is understood that these example matrix dimensions are meant for demonstration and that the utensil 10 may include food gripping mechanisms 300 arranged in any matrices of any suitable dimensions. It also is understood that adjacent m rows need not be equally spaced apart from one another nor adjacent n columns.

In other embodiments, the mechanisms 300 may be arranged in other patterns, such as, without limitation, circular patterns, radial patterns, offset rows and columns, triangular patterns, polygonal patterns, spiral patterns, accordion patterns, zig-zag patterns, other suitable patterns, and any combinations thereof.

In other embodiments, the mechanisms 300 may be arranged in a combination of one or more matrices and/or other patterns. For example, some mechanisms 300 may be arranged in a first m×n matrix, and other mechanisms 300 may be arranged in a second m′×n′ matrix, with the first and second matrices adjacent to one another, offset from one another, oriented at offset angles with respect to one another, arranged in other orientations with respect to one another, and/or in any combinations thereof.

In other embodiments, the mechanisms 300 may be arranged randomly and/or semi-randomly, and/or with some mechanisms 300 arranged in one or more pattern(s) as described herein or otherwise and with other mechanisms 300 arranged randomly therewith.

Other example layouts of mechanisms 300 will be described in other sections in relation to other embodiments.

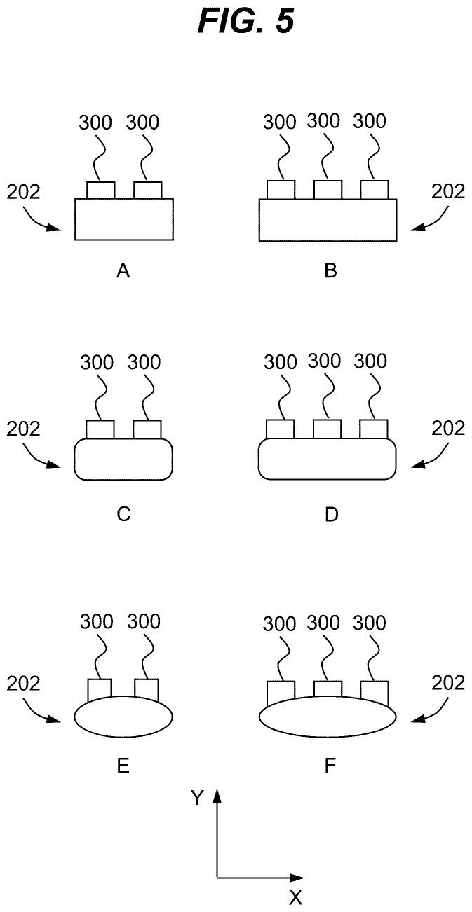

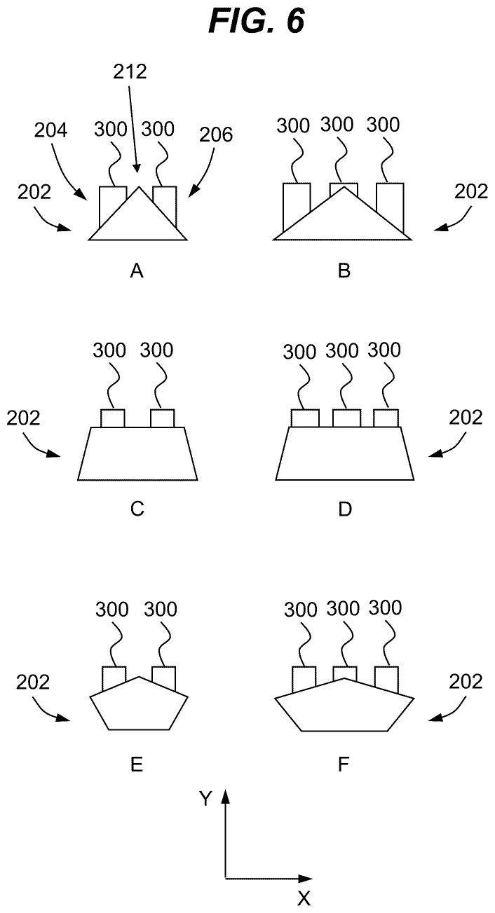

FIGS. 5 and 6 show various examples of cross-sectional shapes of the food holder body 202 (looking into the body's front end 208 in the direction of the arrow A of FIG. 4). For demonstration, each example cross-section is depicted as having two or three columns of food gripping mechanisms 300 coupled to and extending orthogonally upward from the body's top surface 212 (generally along the Y-axis) and it is understood that other numbers of columns also may be implemented.

In a first example, in some embodiments as shown in FIG. 5 images A and B, the body 202 may include rectangular cross-sections with sharp corners, and as shown in images C and D, the corners may be rounded. In another example, as shown in images E and F, the cross-section may be oval (and/or circular). In other embodiments, the cross-section may be triangular as shown in FIG. 6 images A and B, trapezoidal as shown in images C and D, and/or pentagonal as shown in images E and F. It is appreciated that other shaped cross-sections also may be used, such as, without limitation, hexagonal, heptagonal, octagonal, nonagonal, decagonal, and/or other polygonal shapes, and/or any combinations thereof.

It also is understood that the cross-section of the food holding body 202 may be formed as a custom shape, and not necessarily as a traditional geometric shape and/or combinations thereof. This will be described in other sections.

In addition, it is appreciated that some cross-sectional shapes (such as triangular) may not necessarily include a top side 212 comprising a single upper surface from which the food gripping mechanisms 300 may be coupled to and extend outward from. As such, for the purposes of these descriptions, the top side 212 of such shapes may be understood to include an upper portion of the mechanism 300, e.g., comprising a combination of the cross-section's uppermost surface(s), point(s), and/or portion(s), and in addition, as necessary, an upper portion of the left and/or right sides 204, 206 (e.g., see FIG. 6, image A). Given this, depending on the cross-sectional shape utilized, the food gripping mechanisms 300 also may be described as being coupled to and extending outward from one or more portions of the left and/or right sides 204, 206.

While the examples described above depict the food gripping mechanisms 300 extending upward generally orthogonally from the food holding body's upper surface 212 (e.g., generally along the Y-axis), it also is contemplated that the mechanisms 300 may extend at offset angle(s) with respect to the upper surface 212 (e.g., offset from the Y-axis).

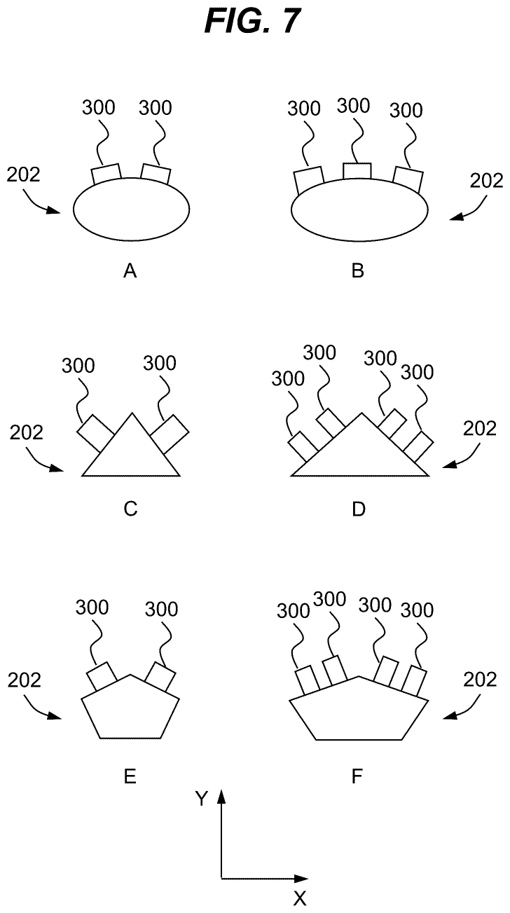

For example, in some embodiments, as shown in FIG. 7 images A and B, the food holding body 202 may include an oval (and/or circular) cross-section with a left column of food gripping mechanisms 300 extending upward and slanting to the left, and with a right column of mechanisms 300 extending upward and slanting to the right. The body 202 also may include an upright and generally orthogonal mechanism 300, e.g., in between the left and right mechanisms 300 as shown in image B.

Similarly, as shown in FIG. 7 images C and D, the body 202 may include a triangular cross-section with one or more columns of mechanisms 300 slanting to the left and one or more mechanisms 300 slanting to the right. In another embodiment, as shown in images E and F, the cross-section may be pentagonal with one or more columns of mechanisms 300 slanting to the left and one or more mechanisms 300 slanting to the right. In these examples, some of the mechanisms 300 may extend orthogonally outward from the surface to which they may be coupled, however, this may not be necessary, and it is understood that the mechanisms 300 may extend at any angle with respect to such surfaces.

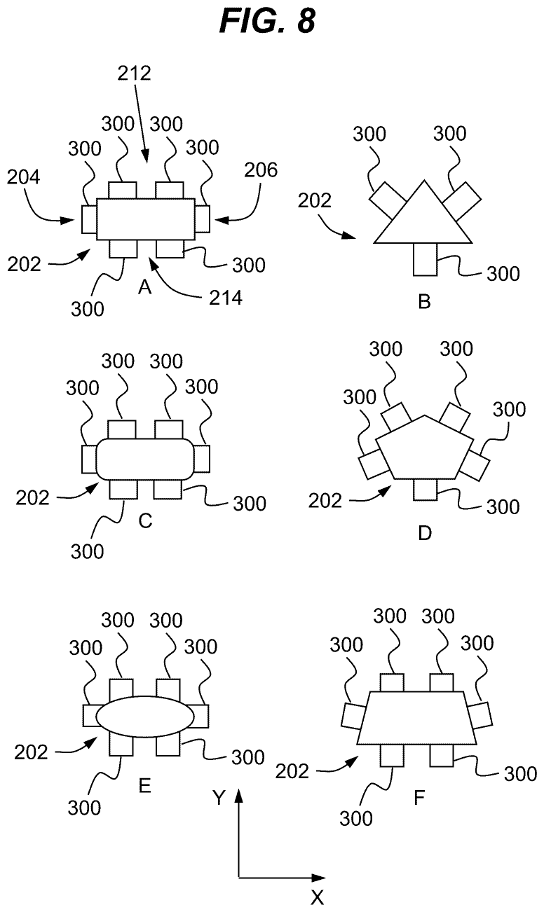

In any of the embodiments described herein, the food holding portion 200 may include one or more food gripping mechanisms 300 coupled to any of its top 212, bottom 214, left 204, and/or right 206 sides, and the mechanisms 300 may be arranged at any suitable orientation(s). FIG. 8 shows examples of various cross-sections with food gripping mechanisms 300 positioned on each of the sides 212, 214, 204, 206 and extending orthogonally therefrom (see FIG. 8, image A). However, it is understood that the embodiments shown in FIG. 8 are meant for demonstration and that the food gripping mechanisms 300 may be positioned at other locations along the various sides 212, 214, 204, 206, that the mechanisms 300 need not be located on each and every side 212, 214, 204, 206, that other numbers of mechanisms 300 may be located on one or more of the sides 212, 214, 204, 206, and that the mechanisms 300 may be oriented in other ways with respect to the sides 212, 214, 204, 206.

In some embodiments, food gripping mechanisms 300 coupled to a side 204, 206 of the food holding body 202 may grip portions of the one or more noodles that may hang over the sides 204, 206 of the body 202. In this way, these side mechanisms 300 may assist other food gripping mechanisms 300 that may be coupled to the top side 212 of the body 202 with holding the noodles.

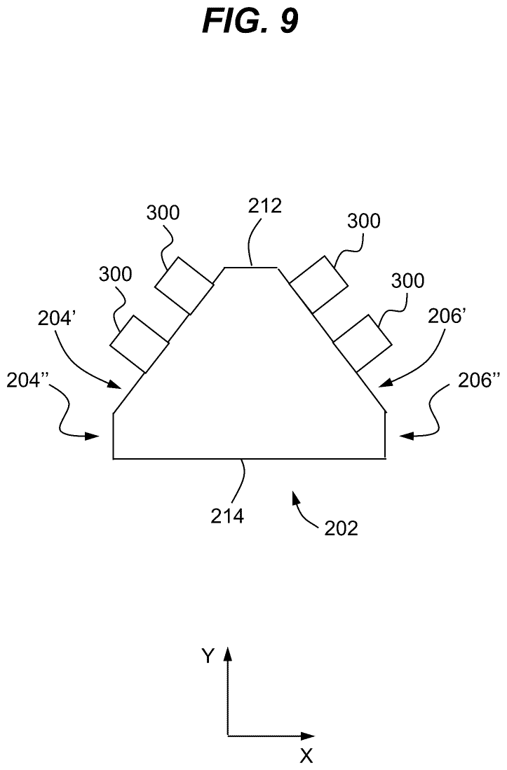

In some embodiments, the food holding body's cross-section may be formed as a custom shape. For example, the cross-section may include a combination of one or more elements or aspects taken from one or more of the cross-sectional shapes described herein or otherwise. In one example of this, as shown in FIG. 9, the cross-section may include an upper portion comprising a top side 212 and left and right slanted side portions 204′, 206′, wherein the elements 212, 204′, 206′ generally resemble the top and left and right sides of a trapezoid. In some embodiments, the cross-section also may include generally vertical left and right side portions 204″, 206″ beneath the left and right slanted side portions 204′, 206′, and a lower generally horizontal bottom side 214, wherein the elements 204″, 206″, 214 generally resemble the bottom and left and right sides of a rectangle. In one example of this arrangement, the food gripping mechanisms 300 may be coupled to the left and right slanted side portions 204′, 206′ and may extend generally orthogonally and/or at offset angles therefrom.

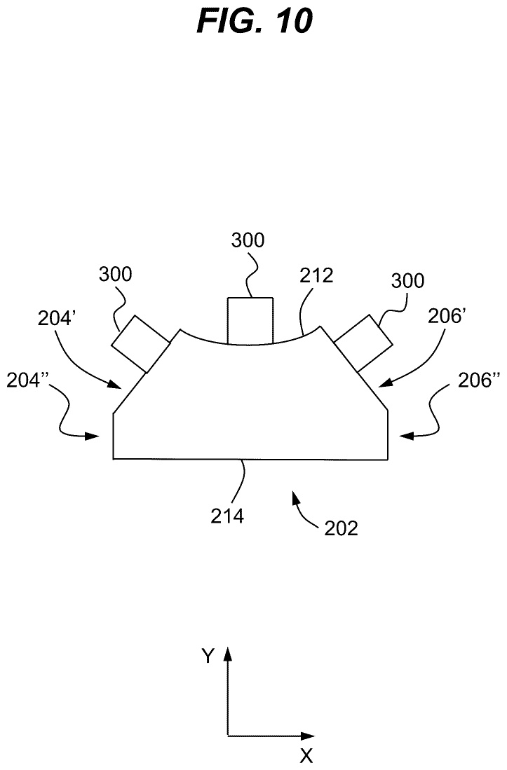

In another example of a custom shaped cross-section as shown in FIG. 10, in some embodiments, the food holder portion's top side 212 may include a concave curvature between the left and right side portions 204′, 206′ that may be formed to hold a small portion of fluid (e.g., a small amount of the soup's broth) so that the utensil 10 also may hold and transport the small portion of broth along with the one or more noodles to the user's mouth. It also is contemplated that other portions of the food holding body 202 (e.g., the left and/or right sides 204, 206) also may include concave curvatures (e.g., cavities) that also may be configured to hold broth during use. It also is contemplated that the food holding body's upper surface 212 may include a concave curvature between the body's front side 208 and its rear side 210 for similar purposes.

In any event, it is understood that the food holder body 202 may include any suitable cross-sectional shape(s) with any number of food gripping mechanisms 300 extending outward from its top side 212, from its left and/or right sides 204, 206, and/or from its bottom side 214 and in any suitable orientation(s) with respect thereto.

In some embodiments, the food holding portion 200 may be about 2 mm to about 20 mm wide (from the left side 204 to the right side 206), and preferably about 4 mm to about 15 mm wide, and more preferably about 5 mm to about 10 mm wide. In addition, in some embodiments, the food holding portion 200 may be about 2 mm to about 20 mm tall (from the bottom side 214 to the top side 212), and preferably about 4 mm to about 15 mm tall, and more preferably about 5 mm to about 10 mm tall. Further, in some embodiments, the food holding portion 200 may be about 2 mm to about 40 mm long (from the front side 208 to the back side 210), and preferably about 4 mm to about 30 mm long, and more preferably about 10 mm to about 20 mm long.

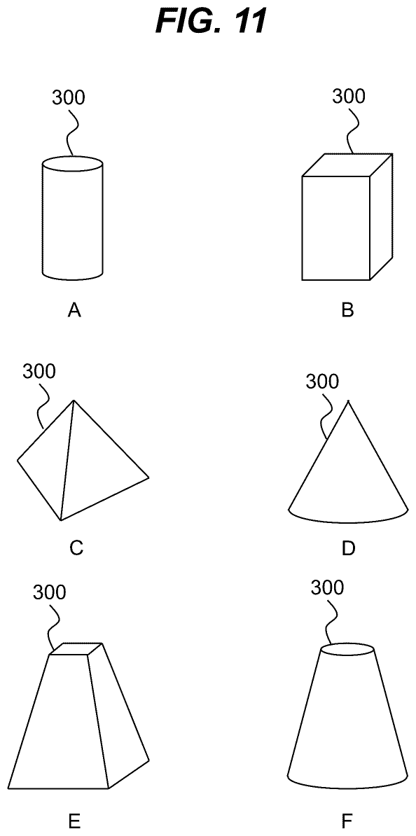

In some embodiments, as shown in FIG. 11, the food gripping mechanisms 300 may be formed as one or more shapes. For example, as shown in FIG. 11 image A, a food holding mechanism 300 may be generally cylindrical. In other embodiments, a mechanism 300 may be formed as a cuboid as shown in image B, as a pyramid as shown in image C, and/or as a cone as shown in image D. A mechanism 300 also may be formed as a frustum of any kind, such as the frustum of a pyramid as shown in image E (also referred to as a truncated pyramid), and/or as a frustum of a cone as shown in image F.

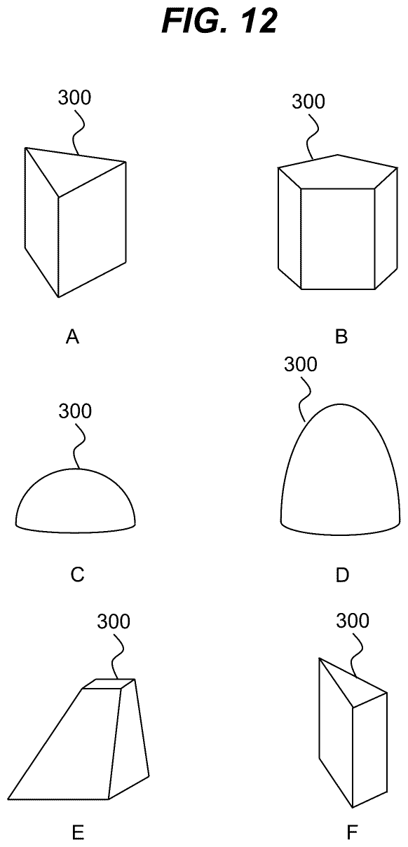

In other embodiments, as shown in FIG. 12, a food holding mechanism 300 may be formed as a prism, e.g., as a triangular prism as shown in image A, a pentagonal prism as shown in image B, and/or as any other type of prism with any number of sides. As such, it is understood that a food holding mechanism 300 may be formed as any polyhedron (including irregular polyhedrons) including, but not limited to, any prism with any number of sides, any pyramid with any number of sides, and/or any platonic solid with any number of sides.

Additionally, in some embodiments, as shown in FIG. 12 image C, a mechanism 300 may be formed as a hemisphere, and/or as a half ellipsoid as shown in image D.

In some embodiments, as shown in FIG. 12 image E, a food holding mechanism 300 may be formed as an irregular pyramid (or a frustum of an irregular pyramid), and/or as an irregular prism as shown in image F.

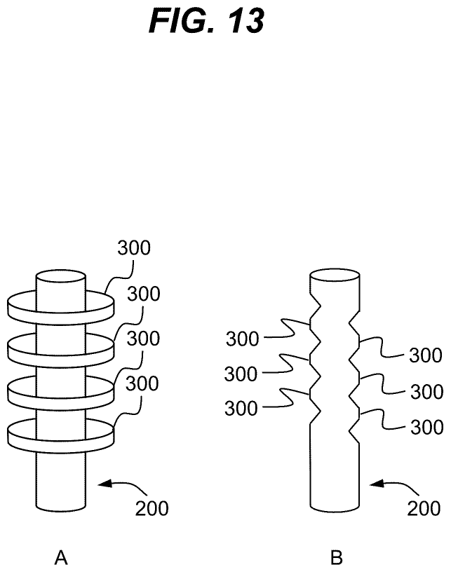

In an alternative embodiment, as shown in FIG. 13 image A, the food gripping mechanisms 300 may be formed as one or more coaxial rings or disks that generally extend about the outer circumferential surface of the food holding body 202. The rings may be generally centered about a center line longitudinal axis of the body 202 (as shown) and/or may be offset. The rings may be equally spaced from one another and/or may be positioned at offset spacings. Also, while the cross-section of the food holding body 202 in FIG. 13 image A is shown to be generally circular, it is understood that the cross-section may be formed as other shapes.

In another alternative embodiment, as shown in FIG. 13 image B, the good gripping mechanisms 300 may be formed by forming a notch, crevice, or channel in one or more sides of the food holding body 202. While the notches shown in FIG. 13 image B are shown to be offset from opposing notches on the opposite side of the body 202, the notches may be arranged in any position relative to one another. In addition, the cross-section of the body 202 may be generally circular as shown and/or may be formed as other shapes.

In some embodiments, any of the edges of any of the forms and/or shapes of the food gripping mechanisms 300 may be sharp and/or rounded. In some embodiments, depending on the size and type of the noodles being gripped, sharp edges may facilitate a greater gripping action.

In some embodiments, any of the sides, forms and/or shapes of the food gripping mechanisms 300 may be linear and/or may include one or more curvatures, such as, without limitation, concave, convex, parabolic, and/or any combinations thereof.

It is understood that the food gripping mechanisms 300 may be formed as any combination of any of the shapes described herein, and that the mechanisms 300 need not match one another.

In some embodiments, the food gripping mechanisms 300 may be about 0.5 mm to about 5 mm tall, and preferably about 0.5 mm to about 3 mm tall, and more preferably about 1 mm to about 2 mm tall. In addition, in some embodiments, the mechanisms 300 may be about 0.2 mm to about 2 mm wide, and preferably about 0.5 mm to about 1.5 mm wide, and more preferably about 1 mm wide.

In any of the embodiments described herein, the utensil 10 may comprise plastic, metal, wood, composite materials, other materials, and any combinations thereof. It may be preferable that the material used be rigid and/or semi-rigid. In addition, the utensil 10 may be produced using conventional manufacturing techniques (e.g., injection molding, extrusion, etc.), using additive manufacturing techniques (e.g., three-dimensional printing), and/or by using any other suitable manufacturing processes.

It is understood that any aspects or elements of any of the embodiments of the stabilization assembly 10 may be combined with any other aspects or elements of any other embodiments of the stabilization assembly 10 to form additional embodiments of the stabilization assembly 10 that also are within the scope of the stabilization assembly 10.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

What is claimed is:

1. An eating utensil comprising:
a handle member including a first end and a second end;
a food holding member coupled to the first end of the handle member; and
at least one food gripping mechanism coupled to the food holding member and extending outward therefrom;
wherein the at least one food gripping mechanism includes a protrusion adapted to grip at least one noodle.

2. The eating utensil of claim 1 wherein the food holding member includes an upper surface and the at least one food gripping mechanism is coupled to the upper surface.

3. The eating utensil of claim 2 wherein the at least one food gripping mechanism includes a plurality of food gripping mechanisms arranged in one or more rows and in one or more columns coupled to the upper surface.

4. The eating utensil of claim 3 wherein the one or more rows includes a total of six to ten rows and the one or more columns includes a total of two to three columns.

5. The eating utensil of claim 1 wherein the food holding member includes an upper surface and a first side surface and a first at least one food gripping mechanism is coupled to the upper surface and a second at least one food gripping mechanism is coupled to the side surface.

6. The eating utensil of claim 5 wherein the at least one food gripping mechanism includes a first plurality of food gripping mechanisms arranged in one or more first rows and in one or more first columns coupled to the upper surface and a second plurality of food gripping mechanisms arranged in one or more second rows and in one or more second columns coupled to the first side surface.

7. The eating utensil of claim 6 wherein the one or more first rows includes a first total of six to eight first rows and the one or more first columns includes a second total of two to three first columns, and the one or more second rows includes a third total of six to eight second rows and the one or more second columns includes a fourth total of two to three second columns.

8. The eating utensil of claim 6 wherein a first of the one or more columns is offset from a second of the one or more columns.

9. The eating utensil of claim 6 wherein a first of the one or more rows is offset from a second of the one or more rows.

10. The eating utensil of claim 1 wherein the food holding member includes a proximal end and a distal end defining a member longitudinal axis, and a cross-section of the food holding member taken perpendicular to the member longitudinal axis is square, rectangular, circular, oval, or polygonal.

11. The eating utensil of claim 10 wherein the cross-section of the food holding member is triangular.

12. The eating utensil of claim 11 wherein the triangular cross-section includes a first leg and a second leg, and a first at least one food gripping mechanism is coupled to the first leg and a second at least one food gripping mechanism is coupled to the second leg.

13. The eating utensil of claim 12 wherein the first at least one food gripping mechanism includes a first plurality of food gripping mechanisms arranged in one or more first rows and in one or more first columns, and the second at least one food gripping mechanism includes a second plurality of food gripping mechanisms arranged in one or more second rows and in one or more second columns.

14. The eating utensil of claim 13 wherein the one or more first rows includes a first total of six to ten first rows and the one or more first columns includes a second total of two to three first columns, and the one or more second rows includes a third total of six to ten second rows and the one or more second columns includes a fourth total of two to three second columns.

15. The eating utensil of claim 1 wherein the food holding member includes a first surface and the at least one food gripping mechanism extends perpendicular from the first surface.

16. The eating utensil of claim 1 wherein the food holding member includes a first surface and the at least one food gripping mechanism extends at an offset angle with respect to the first surface.
